(19) United States
(12) Patent Application Publication
(10) Pub. No.: US 2013/0265375 A1
(43) Pub. Date: Oct. 10, 2013

(54) Process, Dispersion and Ink

(71) Applicants: Mark HOLBROOK, Manchester (GB); Yvonne Margaret ASTEN, Manchester (GB)

(72) Inventors: Mark HOLBROOK, Manchester (GB); Yvonne Margaret ASTEN, Manchester (GB)

(21) Appl. No.: 13/856,501

(22) Filed: Apr. 4, 2013

(30) Foreign Application Priority Data
Apr. 5, 2012 (GB) 1206125.5
Oct. 9, 2012 (GB) 1218071.7

(51) Int. Cl. C08K 5/23; C09D 11/00

(52) U.S. Cl. CPC C08K 5/23; C09D 11/322
USPC 347/95; 524/190

(57) ABSTRACT

A dispersion of an encapsulated particulate solid is described, which is obtained by a process comprising the steps of providing a dispersion comprising a particulate solid, a liquid medium and a dispersant which is obtained or obtainable by copolymerising a monomer composition; and cross-linking the dispersant in the presence of the particulate solid and the liquid medium, thereby encapsulating each particulate solid particle within a cross-linked dispersant shell.

### TECHNICAL FIELD

The present invention relates to a process for preparing a dispersion of an encapsulated particulate solid, it relates to dispersions prepared by the process and to ink jet printing inks containing the dispersions.

### INTRODUCTION

Pigment-based inks generally contain a pigment dispersed in a liquid medium. In contrast to dye-based inks the pigment is insoluble in the liquid medium.

For pigment-based inks it is particularly desirable to obtain high optical density (OD), especially when the ink is printed onto plain paper. It is also desirable to readily obtain an ink containing a fine (sub micron) dispersion of the pigment particles in the liquid medium. Such inks are also desirably colloidally stable during storage or use (e.g. printing). That is to say, that desired inks preferably show little or no flocculation or aggregation of the pigment particles during storage or use. For many inks it is desirable to incorporate significant amounts of water miscible organic liquids. We have found that known pigment dispersions are prone to flocculation in the presence of water miscible organic liquids.

In pigment-based inks the pigment particles are often colloidally stabilised by means of a dispersant.

In our own studies we have found that many classes of particulate solids are especially prone to various mechanisms of colloidal destabilisation. Many yellow pigments and azo pigments are especially prone to colloidal instability. In our studies, C.I. Pigments such as Pigment Yellow 74 and 155 are especially difficult to colloidally stabilise sufficiently well for use in ink jet printing inks.

In addition, many yellow and magenta pigments suffer from inferior light-fastness as compared to carbon blacks or phthalocyanine blue pigments. The differences in fade rate can cause the colour of printed images to appear to shift after exposure to bright light. Typically, faded images turn to cooler more blue tones.

Furthermore, yellow pigments in particular tend to be difficult to mill to sub micron particle sizes using presently available dispersants. High milling energies or long milling times are often required to provide pigment dispersions where the particles are sufficiently small for ink jet printing inks. This is highly undesirable in terms of production times, wear on the mills, product purity and production costs.

It is also desirable to use dispersants which do not require significant amounts of water miscible organic liquids so as to adequately dissolve in an aqueous liquid medium.

### PRIOR ART

PCT patent publication WO 2006/064193 discloses encapsulated particulate solids with good colloidal stability. That said, further improvements in the optical density of printed images were desired.

PCT patent publication WO 2010/038071 discloses encapsulated particulate solids comprising dispersants with large amounts of benzyl methacrylate. These dispersions provide printed images with good optical densities. However, our own work has shown that further improvements in light-fastness are required.

Commercially, there still remains a need for dispersions which solve, at least in part, one or more of the above problems. In particular, there is a need for a dispersion which simultaneously provides good light-fastness, good optical density and good colloidal stability. We have found that attaining these properties simultaneously, especially with yellow and azo pigments, is very difficult.

### DESCRIPTION OF THE INVENTION

According to a first aspect of the present invention there is provided a process for preparing a dispersion of an encapsulated particulate solid comprising the steps in the order I) followed by II):
I) providing a dispersion comprising a particulate solid, a liquid medium and a dispersant which is obtained or obtainable by copolymerising a monomer composition comprising at least the ethylenically unsaturated monomers in components a) to d):
a) from 0.1 to 30 parts of one or more ethylenically unsaturated monomers of the Formula (1):

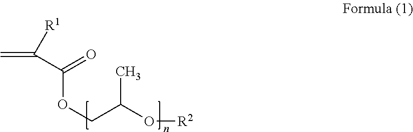

wherein R¹ is H or CH₃, R² is H or C₁₋₃₀ alkyl and n is 1 or more;
b) from 45 to 95 parts one or more ethylenically unsaturated monomers of the Formula (2):

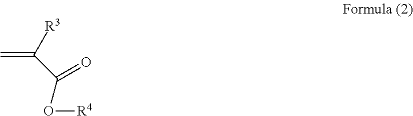

wherein R³ is H or CH₃ and R⁴ is a C₆₋₃₀ alkyl group;
c) from 5 to 30 parts of one or more ethylenically unsaturated monomers each having one or more ionic groups; and
d) from 0.1 to 15 parts of one or more ethylenically unsaturated monomers of the Formula (3):

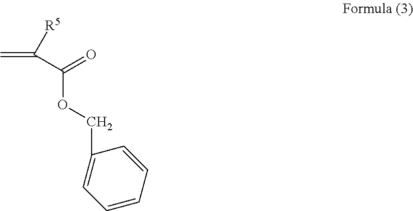

wherein R⁵ is H or CH₃;
wherein the parts are by weight and the sum of all the monomers present in the monomer composition adds up to 100;
II) cross-linking the dispersant in the presence of the particulate solid and the liquid medium and thereby encapsulating each particulate solid particle within a cross-linked dispersant shell.

### DEFINITIONS

Unless stated to the contrary any items expressed to be in the singular, for example using words such as “a” and “an” mean one or more of that item. So for example, a particulate solid means one or more particulate solids.

### Particulate Solid

Any suitable particulate solid may be used without particular limitation.

The particulate solid may comprise and preferably is an inorganic or organic solid material or mixture thereof which is insoluble in the liquid medium. By insoluble we mean a solid having a solubility of no more than 1%, more preferably no more than 0.1% by weight in the liquid medium. The solubility is preferably measured at 20° C. The solubility is preferably measured in water at a neutral pH (7.0).

Examples of suitable particulate solids are extenders and fillers for paints and plastics materials; optical brightening agents; particulate ceramic materials; magnetic particles (e.g. for use in magnetic recording media); metallic particles, polymeric particles, biocides; agrochemicals; pharmaceuticals and colorants.

Preferably, the particulate solid is a colorant. Preferably, the colorant is a pigment or an insoluble dye, more preferably a pigment. Accordingly, it is preferred that the particulate solid is or comprises a pigment.

The pigment may be of any kind and is especially selected from those pigments suitable for preparing inks. Preferably, the pigment is organic or inorganic.

The pigment may be any of the classes of pigments described in the Third Edition of the Colour Index (1971) and subsequent revisions of, and supplements thereto, under the chapter headed “Pigments”.

Examples of suitable organic pigments are those from the azo (including disazo and condensed azo), thioindigo, indanthrone, isoindanthrone, anthanthrone, anthraquinone, isodibenzanthrone, triphendioxazine, quinacridone and phthalocyanine series, especially copper phthalocyanine and its nuclear halogenated derivatives, and also lakes of acid, basic and mordant dyes. Preferred organic pigments are phthalocyanines, especially copper phthalocyanine pigments, azo pigments, indanthrones, anthanthrones, quinacridones pigments.

It is especially preferred that the organic pigment is a quinacridone or azo pigment, more especially an azo pigment. In our studies we have found that the benefits of the present invention such as light-fastness and colloidal stability are especially pronounced when using these pigments.

A preferred class of azo pigments are the compounds comprising a group of the Formula (4):

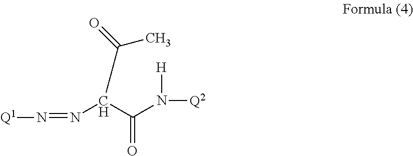

wherein Q¹ and Q² are each independently optionally substituted aryl groups.

Preferably, Q¹ and Q² are each independently optionally substituted naphtylene or phenylene rings. Preferred pigments having this structure are C.I. Pigment Yellow 74 and 155, especially Yellow 74.

Preferred inorganic pigments include: metal oxides, sulfides, nitrides and carbides (e.g. titanium dioxide and silicon dioxide), metallic pigments (e.g. aluminium flake) and especially carbon black. Of these carbon black is particularly preferred.

Preferably, the pigment is a cyan, magenta, yellow or black pigment, especially a magenta or yellow pigment, more especially a yellow pigment. We have found that yellow pigments tend to show especially pronounced benefits including light-fastness and colloidal stability when used with the present invention. Especially preferred particulate solids are the C.I. Pigment Yellows of which C.I. Pigment Yellow 1, 3, 10, 12, 13, 14, 17, 55, 65, 73, 74, 75, 83, 93, 97, 109, 111, 120, 128, 138, 139, 150, 151, 154, 155, 180, 185 and 213 are preferred. Of these C.I. Pigment Yellow 155 and especially 74 are preferred. For shading purposes it may be desirable to use mixtures of Pigments (especially C.I. Pigment Yellows) in the present invention.

The pigment may be a single chemical species or a mixture comprising two or more chemical species (e.g. a mixture comprising two or more different pigments). In other words, two or more different pigments may be used in the process of the present invention. Where two or more pigments are used these need not be of the same colour or shade.

Preferably, the particulate solid is not dispersible in an aqueous liquid medium (especially pure water) without the aid of a dispersant, i.e. the presence of a dispersant is required to facilitate dispersion. Preferably, the particulate solid is not chemically surface treated, for example by having ionic groups covalently bonded to its surface (especially not —CO₂H or —SO₃H).

The particulate solid preferably has an average particle size of less than 1 micron, more preferably from 30 to 500 nm, especially from 30 to 200 nm and most especially from 50 to 170 nm. The average particle size may be the Z or volume average size, more preferably the Z average. Any suitable method for measuring the particle size may be used but the preferred method is light scattering. The average size preferably relates to the effective particle diameter. A preferred apparatus for measuring the particle size is the Zetasizer™ available from Malvern.

### Dispersion

Preferably, the dispersion is fluid at 25° C. More preferably the dispersion is a liquid dispersion at 25° C.

### Liquid Medium

Preferably, the liquid medium is not curable, for example by radiation such as UV cure or electron beam cure. Preferably, the liquid medium is liquid at a temperature of 25° C., more preferably all the liquid components in the liquid medium are liquid at a temperature of 25° C.

The liquid medium preferably is or comprises water, accordingly the dispersion prepared in the process of the first aspect of the present invention is preferably aqueous. In addition to water the liquid medium may comprise one or more organic liquids which are preferably water-miscible organic liquids.

Preferably, whilst preparing the dispersion in steps I) and II) liquid medium comprises water and at least one water-miscible organic liquid in a weight ratio of 60:40 to 99.9:0.1, more preferably 80:20 to 99.5:0.5, especially from 90:10 to 99:1 and most especially 95:5 to 99:1.

Preferred water-miscible organic liquids present in the liquid medium during preparation of the encapsulated particulate solid include alcohols (especially glycols), ketones, ethers, amides (especially cyclic amides) and sulfolane. Whilst preparing the encapsulated particulate solid the water miscible organic liquid is preferably dipropylene glycol.

### Dispersant

Preferably, prior to cross-linking the dispersant is soluble in water. Preferably, prior to cross-linking the dispersant has a solubility in water of at least 10% by weight, more preferably of at least 20% by weight. The solubility is preferably measured at a temperature of 25° C. A preferred method for measuring the solubility is to heat a mixture of the dispersant and water to 80° C. for a period of 2 hours with continuous agitation of the mixture. The mixture is then cooled to a temperature of 25° C. and allowed 24 hours to re-equilibrate. The amount of dissolved material is preferably established by filtration or centrifugation to remove the undissolved dispersant. The amount of dissolved dispersant may be established by refractive index, UV-Vis or gravimetric methods. The dispersant solubility is preferably measured in the fully (100%) neutralised form. For anionic dispersant the preferred base is potassium hydroxide, for cationic dispersants the preferred acid is hydrochloric acid.

Preferably, the dispersant has an acid value of from 1 to 3 mmoles of acid groups per g of dispersant. More preferably the acid value of the dispersant is from 1 to 2 mmoles, especially from 1.2 to 1.8 mmoles and most especially from 1.3 to 1.6 mmoles per g of dispersant.

The weight averaged molecular weight of the dispersant is preferably from 500 to 1,000,000, more preferably from 1,000 to 200,000, especially from 1,000 to 50,000, more especially from 3,000 to 40,000. The weight averaged molecular weight is preferably established by gel permeation chromatography (GPC). A preferred solvent for GPC is dimethyl formamide. The molecular weight standards used to calibrate the GPC method are preferably polystyrene.

The dispersant used in the present invention may be prepared by any suitable polymerisation method. Examples include dispersion, emulsion, bulk and especially solution polymerisation. The polymerisation initiation mechanism can be anionic, cationic, group transfer, atom transfer but is preferably free radical.

The monomer repeat units derived from the components a) to d) and optionally e) can be disposed in the final dispersant structure in the form of blocks (or segments) or more preferably they can be randomly (or statistically) distributed.

The dispersant is a copolymer obtained by polymerising the ethylenically unsaturated monomers in components a) to d) and optionally e).

Prior to cross-linking the dispersant is preferably at least partially adsorbed onto the surface of the particulate solid.

The dispersion in step 1) may comprise a mixture of dispersants obtainable from copolymerising the ethylenically unsaturated monomers a) to d) and optionally e).

Preferably, the amount of dispersant present in the dispersion is from 5 to 200%, more preferably from 10 to 100%, especially from 15 to 80% and more especially from 20 to 70% by weight relative to the weight of the particulate solid present in the dispersion.

### Component a)

In order of increasing preference component a) is present in an amount of from 1 to 30, 1 to 25, 5 to 25, 10 to 25, 12 to 22, 13 to 20, 14 to 19 and 15 to 18 parts by weight. The preferred amounts provide dispersions having better OD and provide dispersants which are more soluble in water without the need for larger amounts of water-miscible organic liquids.

Preferably, in Formula (1) R¹ is CH₃.

Preferably, in Formula (1) n is from 1 to 100, more preferably from 1 to 30, especially from 1 to 20, more especially from 1 to 10 and most especially from 3 to 8.

Preferably, in Formula (1) R² is H. Preferably, in Formula (1) R¹ is CH₃ and R² is H.

Consequently, component a) preferably comprises one or more hydroxy terminated polypropylene glycol methacrylate monomers. Preferably, component a) is comprised exclusively of these monomers.

### Component b)

Preferably, component b) is present in an amount of from 45 to 85, more preferably from 50 to 80, especially from 55 to 75, more especially from 60 to 70 and most especially from 62 to 68 parts by weight.

Preferably, in Formula (2) R³ is CH₃.

Preferably, in Formula (2) R⁴ is a hexyl, octyl, decyl, lauryl, stearyl and especially a 2-ethyl hexyl group.

Preferably component b) comprises 2-ethyl hexyl methacrylate.

Preferably component b) is 2-ethyl hexyl methacrylate. That is to say that no other monomers in component b) are present.

### Component c)

Preferably, component c) is present in an amount of from 5 to 25, more preferably from 7 to 25, especially from 7 to 20, more especially from 10 to 16 and most especially from 11 to 15 parts by weight.

The ionic group(s) in the ethylenically unsaturated monomers of component c) may be cationic or more preferably anionic. Preferred anionic groups include sulfonic acid, phosphonic acid and especially carboxylic acid.

Preferred ethylenically unsaturated monomers having carboxylic acid groups include beta carboxylethyl acrylate, itaconic acid, maleic acid, fumaric acid, crotonic acid, more preferably acrylic acid and especially methacrylic acid.

Preferably component c) comprises methacrylic acid, more preferably component c) is methacrylic acid (and no other monomers are present in component c).

### Component d)

It is advantageous to include component d) at from 0.5 to 15, more preferably from 1 to 15, especially from 1 to 10, more especially from 2 to 8 and most especially from 3 to 7 parts by weight.

One aspect of the present invention is the requirement for small amounts of monomers of component d). Whilst not wishing to limited by any theory it is believed that the methylene group attached to the benzene ring in the ethylenically unsaturated monomers of Formula (3) are structurally susceptible to free radical fragmentation on exposure to light. These radicals are thought to attack the pigment, especially where the pigment is a yellow, magenta or azo pigment. We consider this to be one possible explanation as to why we have observed that a reduction in the amount of component d) improves the light-fastness of inks containing the present dispersions. What is surprising to the inventors is that the presence of small amounts of the monomers in component d) does not adversely impact on light-fastness but does positively contribute to improved optical density.

Preferably, in Formula (3) R⁵ is CH₃. In other words the preferred ethylenically unsaturated monomer for component d) is benzyl methacrylate. Preferably, component d) comprises benzyl methacrylate, more preferably component d) is benzyl methacrylate (preferably benzyl acrylate is not present in component d).

### Component e)

The monomer composition used to prepare the dispersant may optionally comprise component e) one or more ethylenically unsaturated monomers other than those in components a) to d).

Preferably, component e) is present in an amount from 0 to 20 parts, more preferably from 0 to 15 parts, especially from 0 to 10 parts, more especially from 0 to 5 parts and even more especially from 0 to 1 part by weight. In a most preferred case component e) is absent. In other words, the monomers used to prepare the dispersant consist only of components a) to d) and accordingly the sum of the parts a) to d) is 100 parts by weight.

The ethylenically unsaturated monomers for component e) may be of any kind. The monomers in component e) may be non-ionic and hydrophilic, examples of which include (meth) acrylamide, vinyl pyrrolidone, hydroxy ethyl (meth)acrylate and polyethyleneoxy (meth)acrylate. Preferably, component e) does not comprise an ethylenically unsaturated monomer having a polyethyleneoxy group. More preferably, component e) does not comprise any monomers which are both non-ionic and hydrophilic. In our studies such monomers tend to reduce the optical density of the final printed image.

More preferred monomers for component e) are non-ionic and hydrophobic. Suitable examples are styrenics (especially styrene and alpha-methyl styrene), C₁₋₅ alkyl methacrylates, aromatic (meth)acrylates other than those in component d). Preferably, component e) contains no styrenic monomers. Component e) may comprise macromonomers such as those obtained from co-polymerising styrenic monomers. Preferably, macromonomers and especially styrenic macromonomers are absent from component e).

### Components a) to d)

The components a) to d) preferably add up to 80 parts, more preferably 85 parts, especially 90 parts, more especially 95 parts, even more especially 99 parts and most especially 100 parts by weight. Component e) is present in a sufficient amount such the components a) to e) add up to 100 parts by weight.

### Providing

Preferably, the dispersion in step 1) is prepared by dispersing the particulate solid, with the dispersant in the liquid medium. Preferably, the dispersant as described above accounts for at least 50%, more preferably at least 70%, especially at least 90% and most especially 100% by weight of all the dispersants present during the dispersion step. The method of dispersion may utilise fairly low energies. Examples of which include stirring, blending, shaking, rolling and the like. For pigments in particular, dispersion using low energies does not tend to provide particles having a sufficiently small size for use in inks and ink jet printing inks. More preferably the method of dispersion comminutes the particulate solid to the previously mentioned preferred average particle size. Preferred methods of comminution include microfluidization, ultrasonication, high pressure homogenisation, and especially bead milling.

One advantage of the present invention is that we have observed useful and desirable reductions in the total dispersion energy (milling energy) when using the dispersants of the present invention.

The benefit is particularly noticeable with azo or yellow pigments (especially C.I. Pigment Yellows 155 and more especially 74).

### Cross-Linking

The cross-linking in step II) functions to encapsulate the particulate solid particles within a cross-linked dispersant shell. Accordingly, the result is a dispersion of particulate solid particles each particle being encapsulated by a cross-linked dispersant shell.

The cross-linking reaction may cross-link the polymeric dispersant by ionic or more preferably by covalent bonds.

The cross-linking reaction in step II) may be by self cross-linking wherein the dispersant contains co-reactive groups. For example component e) may comprise ethylenically unsaturated monomers having isocyanate, oxetane, carbodiimide, aziridine, n-methylol or epoxy groups. These preferably react with the ionic groups derived from the monomers in component c).

More preferably, the cross-linking step is effected by the addition of a cross-linking agent. The cross-linking agent may have isocyanate, oxetane, carbodiimide, aziridine, n-methylol and epoxy groups or mixtures thereof. Preferably, the cross-linking agent has at least two epoxy groups. Preferably, the cross-linking agent is an epoxy cross-linking agent.

Preferred epoxy cross-linking agents include sorbitol polyglycidyl ether, glycerol polyglycidyl ether, polyglycerol polyglycidyl ether, pentaerythritol polyglycidyl ether, trimethylolpropane polyglycidyl ether, resorcinol diglycidyl ether, neopentyl glycol diglycidyl ether, 1,6-hexanediol diglycidyl ether, hydrogenated bisphenol A diglycidyl ether, ethylene glycol diglycidyl ether, polyethylene glycol diglycidyl ether, propylene glycoldiglycidyl ether, polypropylene glycol diglycidyl ether, polybutadiene diglycidyl ether. Of these polyethene glycol diglycidyl ether, trimethylolpropane polyglycidyl ether and polyglycerol polyglycidyl ether are preferred. Cross-linking agents of this kind can be obtained commercially under the Denacol™ tradename from Nagasechemtex.

The temperature for the cross-linking step is preferably from 30 to 150° C., more preferably from 30 to 120° C., especially from 30 to 100° C., more especially from 40 to 80° C. and most especially from 50 to 80° C.

The time for maintaining the above temperature varies widely. The time required can be as little as 30 minutes or as much as 48 hours. In many cases the above preferred temperature is maintained preferably from 1 to 10 hours, more preferably from 2 to 8 hours and especially from 2 to 6 hours.

Preferably, the cross-linking step II) is performed in the presence of a boric acid and/or borate salts.

Preferably, the amount of cross-linking agent added is sufficient to cross-link from 5 to 80 mole %, more preferably from 10 to 70 mole % and especially from 20 to 60 mole % of the cross-linkable groups in the dispersant. The preferred cross-linkable groups being the ionic groups in the monomer units from component c).

### Purification

Preferably, the dispersion is purified after step II). The purification step helps to reduce the amounts of uncross-linked or unencapsulated dispersant, impurities from the particulate solid itself or from the dispersion process and any optional water-miscible organic liquids present in the liquid medium.

The dispersion can be purified by dead-end filtration, centrifugation/decantation/washing, ion exchange resins, electrodialysis or more preferably by ultrafiltration.

Ultrafiltration preferably utilises cross-flow membrane filtration.

The ultrafiltration membrane preferable has a nominal molecular weight cutoff of 20,000 g/mole to 200,000 g/mole.

Preferably, the dispersion after step II) is ultrafiltered with from 5 to 50 volumes of purified water based on the volume of the dispersion. Preferably, the water used in the ultrafiltration process is deionized, distilled or has been purified by reverse osmosis.

After ultrafiltration the liquid medium preferably comprises water and less than 10%, more preferably less than 5%, especially less than 1% and most especially less than 0.1% by weight of one or more water miscible organic liquids.

### Substantially Removing Oversized Particles

Preferably, the dispersion is treated so as to attempt to remove any particulate matter having a particle diameter of greater than 2 microns, more preferably greater than 1 micron and especially greater than 0.5 microns.

Removal of oversized particulate matter may be performed by centrifugation and/or filtration.

### Dispersions Obtained by the Process

According to a second aspect of the present invention there is provided a dispersion of an encapsulated particulate solid obtained or obtainable by the process according to the first aspect of the present invention.

Alternatively when written independently, the dispersion comprises a liquid medium and an encapsulated particulate solid (with each particle of the particulate solid being encapsulated within a cross-linked dispersant shell) wherein the dispersant comprises the repeat units from copolymerising at least the ethylenically unsaturated monomers a) to d). The description and preferences for all aspects of the present invention apply equally to the dispersion written in this independent form.

### Ink Jet Printing Inks

The dispersion may be used to prepare an ink, especially an ink jet printing ink.

According to a third aspect of the present invention there is provided an ink jet printing ink comprising the dispersion.

For inks it is preferred that the particulate solid is a colorant, more preferably an pigment.

Preferably, the ink has a viscosity of less than 50 mPa·s, more preferably less than 30 mPa·s and especially less than 15 mPa·s, when measured at a temperature of 25° C. Preferably the ink viscosity is Newtonian. Preferably, the viscosity is measured using a shear rate of 100 s⁻¹. The viscosity is preferably measured using a cone and plate geometry. A preferred apparatus for measuring the viscosity is a TA Instruments rheometer.

Preferably, the ink has a surface tension of 20 to 65 dynes/cm, more preferably 30 to 60 dynes/cm, when measured at a temperature of 25° C.

The pH of the ink is preferably from 4 to 11, more preferably from 7 to 10.

When the ink is to be used as ink jet printing ink, the ink preferably has a concentration of halide ions of less than 500 parts per million, more preferably less than 100 parts per million. It is especially preferred that the ink has less than 100, more preferably less than 50 parts per million of divalent and trivalent metals. Parts per million as used above refers to parts by weight relative to the total weight of the ink. These low concentrations of ions in the resultant ink can be achieved by the abovementioned purification step.

Preferably, the amount of particulate solid (especially pigment) in the ink is from 0.1 to 15%, more preferably from 1 to 10% and especially from 3 to 10% by weight.

### Water/Organic Liquids in the Inks

Preferably, the ink contains water. More preferably, the ink contains at least 20 wt %, more preferably at least 40 wt % of water relative to the total ink.

Preferably, the ink contains water and organic liquid in the weight ratio of 99:1 to 1:99, more preferably 99:1 to 50:50 and especially 95:5 to 70:30 (water:organic liquid).

Preferred organic liquids are water-miscible organic liquids and mixtures of such liquids. Preferred water-miscible organic liquids include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulphoxides, preferably dimethyl sulphoxide and sulpholane. Preferably, the ink comprises water and 2 or more, especially from 2 to 8, water-miscible organic liquids.

Especially preferred water miscible organic liquids for the ink are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and di-C₁₋₄-alkyl ethers of diols, more preferably mono-C₁₋₄-alkyl ethers of diols having 2 to 12 carbon atoms, especially 2-methoxy-2-ethoxy-2-ethoxyethanol.

Examples of further suitable ink media comprising a mixture of water and one or more organic liquids are described in U.S. Pat. No. 4,963,189, U.S. Pat. No. 4,703,113, U.S. Pat. No. 4,626,284 and EP 0425150A.

In some instances the ink may comprise liquid monomers which may be later polymerised or cured by radiation such as UV or electron beam. More preferably, however, the ink is not curable.

### Additives

It is preferred that the process of the present invention further comprises adding to the dispersion one or more additives selected from viscosity modifiers, pH buffers, metal chelating agents, surfactants, corrosion inhibitors, biocides, dyes, water miscible organic liquids(s) and kogation reducing additives. Preferably, these are added after step II) and after purification. The inks and especially ink jet printing inks preferably comprise one or more of these additives.

### Cartridges

According to a fourth aspect of the present invention there is provided an ink jet printer cartridge containing an ink jet printing ink according to the third aspect of the present invention.

### Printers

According to a fifth aspect of the present invention there is provided an ink jet printer containing an ink jet printer cartridge according to the fourth aspect of the present invention.

### Substrates

The substrate on which the ink is printed may be of any kind including paper, glass, metal, material and plastic. We have found that the inks according to the third aspect of the present invention ink jet print onto substrates to provide prints having especially good optical density even on plain paper.

### EXAMPLES

The present invention will now be illustrated by means of examples in which all parts are by weight unless stated to the contrary.

### Step 1) Providing the Dispersion

### 1.1 Preparation of Dispersant Solution 1 and Comparative Dispersant Solutions 1 to 3

The ethylenically unsaturated monomers and the amounts as listed in Table 1 were mixed with the chain transfer agent in the amount listed in Table 1. Each monomer mixture of ethylenically unsaturated monomers and the chain transfer agent was then dissolved in dipropylene glycol (92.21 g) to give a solution used as the monomer feed.

For each monomer mixture a thermal initiator, Trigonox 21S (3.40 g) was dissolved in dipropylene glycol (122.95 g) to give a solution used as the initiator feed.

The polymerisation to prepare each Dispersant Solution and Comparative Dispersant Solution followed the same method, in a reaction flask dipropylene glycol (159.81 g) was warmed to a temperature of 85° C. and purged with nitrogen gas. Whilst stirring the appropriate monomer feed and one initiator feed were added over 4 and 5 hours respectively by pumping the solutions into the reaction flask. The nitrogen gas atmosphere was maintained throughout. The temperature was maintained at 85° C. (+/−1° C.) throughout. On completion of the feeds the flask contents were stirred for a further 1 hour at 85° C. These steps copolymerised the ethylenically unsaturated monomers to prepare the Dispersant Solutions each in the form of a 40% by weight solution of dispersant in dipropylene glycol.

TABLE 1

| | | Monomers | Monomers | Monomers |
|---|---|---|---|---|
| | Monomers | for | for | for |
| | for | Comparative | Comparative | Comparative |
| | Dispersant | Dispersant | Dispersant | Dispersant |
| Monomer | Solution 1 | Solution 1 | Solution 2 | Solution 3 |
| a) PPG(5)MA | 40.16 g | 50.76 g | — | 36.26 g |
| | (16.6%) | (21.0%) | | (15.0%) |
| b) 2-EHMA | 157.16 g | — | 84.62 g | 84.62 g |
| | (65.0%) | | (35.0%) | (35.0%) |
| c) MAA | 31.47 g | 32.4 g | 57.18 g | 35.39 g |
| | (13.0%) | (13.4%) | (23.65%) | (14.64%) |
| d) BzMA | 12.97 g | 16.4 g | — | — |
| | (5.4%) | (6.8%) | | |
| e) n-BMA | — | 142.15 g | — | — |
| | | (58.8%) | | |
| e) MMA | — | — | 99.97 g | 85.49 g |
| | | | (41.35%) | (35.36%) |
| CTA | 4.82 g | 4.82 g | 16.12 g | 1.38 g |

2-EHMA is 2-ethyl hexyl methacrylate
n-BMA is n-butyl methacrylate
MMA is methyl methacylate
PPG(5)MA is polypropylene glycol (n = 5) methacrylate
BzMA is benzyl methacrylate
MAA is methacrylic acid
CTA means chain transfer agent which was butyl 3-mercaptopropionate.

### 1.2 Dispersant Neutralisation

Each of the Dispersant Solutions and Comparative Dispersant Solutions as prepared above in step 1.1 (625 g) were neutralised by the addition of a solution containing 45% aqueous potassium hydroxide (36.46 g) and water (644.21 g) to give a solids content of 20% by weight. This prepared Neutralised Dispersant Solution 1 from Dispersant Solution 1 and Comparative Neutralised Dispersant Solution 1 from Comparative Dispersant Solution 1 etc.

### 1.3 Preparation of Mill-Base 1 and Comparative Mill-Bases 1 to 3

Pigment powder (22 parts of TRY13—Pigment Yellow 74 pigment ex DNS), Neutralised Dispersant Solution 1 as prepared in step 1.2 (55 parts) and water (23 parts) were mixed together to form a pre-mixture.

The pre-mixture was transferred to a horizontal recirculating bead mill (Netzsch) containing 1 mm beads and initially milled for 45 minutes. After the initial milling the pre-mixture was transferred to another horizontal recirculating bead mill (Netzsch) containing 0.3 mm beads. The pre-mixture was then milled for 10 hours. The resultant dispersion was pumped off the beads and adjusted to 10% by weight of pigment by the addition of pure water. This prepared Mill-base 1. The pigment particles in Mill-base 1 had an Z-average particle size of 118 nm, measured using a Malvern Zetasizer™.

Comparative Mill-bases 1 to 3 were prepared in exactly the same manner but Comparative Neutralised Dispersant Solutions 1 to 3 were each used in place of Neutralised Dispersant Solution 1. Comparative Mill-base 1 used Comparative Neutralised Dispersant Solution 1 etc.

### Step II)

### 2. Cross-Linking the Dispersant so as to Encapsulate the Pigment Particles

The dispersant in each Mill-base and Comparative Mill-base as prepared in step 1.3 was then cross-linked so as to encapsulate the pigment particles in each case using the cross-linking agent polyethylene glycol diglycidyl ether (average molecular weight 526 obtained from Aldrich, hereafter abbreviated as PEGDGE).

This cross-linked the carboxylic acid groups in each dispersant and thereby encapsulated the pigment particles. In each case the cross-linking reaction was controlled by the presence of boric acid (obtained from Aldrich). In every cross-linking step II) a mixture of the appropriate mill-base (500 g), PEGDGE (4.6 g) and boric acid (1.08 g) was prepared. The cross-linking reaction was effected by heating each mixture to a temperature of about 65° C. for 5 hours. This resulted in Encapsulated Pigment Dispersion 1 from Mill-base 1 and Comparative Encapsulated Pigment Dispersion 1 from Comparative Mill-base 1 etc.

### 3. Ultrafiltration

Encapsulated Pigment Dispersion 1 and Comparative Encapsulated Pigment Dispersions 1 to 3 as prepared above in step 2. were purified by means of ultrafiltration using a membrane having a 50 kD molecular weight cut-off. The encapsulated pigment dispersions were each diafiltered with approximately 10 wash volumes of pure deionized water per 1 volume of the encapsulated pigment dispersion. The ultrafiltration membrane was then used to concentrate the encapsulated dispersions back to a solids content of around 10% by weight.

### 4. Ink Preparation

Ink 1 was prepared by adding together the components in the amounts indicated in Table 2.

TABLE 2

| Ink formulation | % by weight |
|---|---|
| Water-miscible organic liquid - Ethylene glycol | 15 |
| Water-miscible organic liquid - Triethylene glycol | 10 |
| monobutyl ether | |
| Surfactant - Surfynol ™ 465 | 0.7 |
| Encapsulated Pigment Dispersion 1 after the | 50 |
| purification step 3. | |
| Water | 24.3 |

Surfynol™ 465 is available from Air Products.

Comparative Ink 1 was prepared in exactly the same way but Comparative Encapsulated Pigment Dispersion 1 after purification replaced purified Encapsulated Pigment Dispersion 1. Comparative Inks 2 and 3 were prepared analogously.

### 5. Ink Stability Tests

The initial Z-average particle diameter of the pigment particles in each Ink and Comparative Ink was measured using a Malvern Zetasizer™. This value is tabulated as Z¹ (nm) in Table 3.

In a similar way the initial Mv-average particle diameter of the pigment particles in each Ink and Comparative Ink was measured using and a Nanotrac™ instrument from Microtrac Inc. This value is tabulated as Mv¹ (nm) in Table 3.

For each Ink and Comparative Ink the initial amount of pigment particles having a diameter greater than 0.5 microns was measured using a Accusizer™ 780-APS instrument and the particle count was expressed as the number of particles>0.5 micron per ml of ink. All samples were measured using the Accusizer™ after being diluted to 1% by weight of pigment in the ink. The initial particle count was normalised to 1.0% by weight pigment content and is tabulated as P¹ in Table 3.

Each Ink and Comparative Ink was stored in a sealed bottle placed in an oven at a temperature of 60° C. for a period of 4 weeks. Each Ink and Comparative Ink was allowed to cool to 25° C. and the above measurements were repeated. In Table 3, Z² tabulates the Z-average particle diameter after storage (nm), Mv² tabulates the Mv²-average diameter after storage (nm) and P² tabulates the particle count normalised to 1.0% by weight pigment content after storage.

After storage the sample bottle was inverted and visually inspected for signs of sedimentation.

### 6. Results

TABLE 3

| | | Comparative | Comparative | Comparative |
|---|---|---|---|---|
| Dispersant | Ink 1 | Ink 1 | Ink 2 | Ink 3 |
| a) PPG(5)MA | 40.16 g | 50.76 g | — | 36.26 g |
| | (16.6%) | (21.0%) | | (15.0%) |
| b) 2-EHMA | 157.16 g | — | 84.62 g | 84.62 g |
| | (65.0%) | | (35.0%) | (35.0%) |
| c) MAA | 31.47 g | 32.4 g | 57.18 g | 35.39 g |
| | (13.0%) | (13.4%) | (23.65%) | (14.64%) |
| d) BzMA | 12.97 g | 16.4 g | — | — |
| | (5.4%) | (6.8%) | | |
| n-BMA | — | 142.15 g | — | — |
| | | (58.8%) | | |
| MMA | — | — | 99.97 g | 85.49 g |
| | | | (41.35%) | (35.36%) |
| Z¹ | 96 | 71 | 94 | 82 |
| Z² | 105 | 88 | 614 | 83 |
| Z² − Z¹ | 9 | 17 | 520 | 1 |
| Mv¹ | 71 | 64 | 74 | 67 |
| Mv² | 80 | 75 | 1337 | 76 |
| Mv² − Mv¹ | 9 | 11 | >1000 | 9 |
| Visual assessment | 1 | 1 | 4 | 0 |
| of sedimentation | | | | |
| P¹ | 8.22E+06 | 1.18E+06 | 2.96E+06 | 3.83E+05 |
| P² | 2.03E+07 | 1.16E+07 | 1.78E+09 | 3.81E+06 |
| P²/P¹ | 2.5 | 10 | 600 | 10 |

The visual assessment of sedimentation used a semi quantitative scale wherein:
0 = no sedimentation;
1 = traces of sedimentation;
2 = some sedimentation;
3 = significant sedimentation;
4 = extensive sedimentation;
5 = almost all or all the pigment has sedimented out.

The most colloidally stable dispersions dispersions show the smallest values for Z²-Z¹, Mv²-Mv¹ and P²/P¹.

As can be seen from Table 3, the dispersions of the present invention have particularly good colloidal stability. This is especially noticeable in the Accusizer™ (P²/P¹) particle count data.

### 7. Further Inks

The further inks described in Tables I and II may be prepared wherein the Encapsulated Pigment Dispersion (EPD) after ultrafiltration and the ink additives are as defined below. Numbers quoted in the second column onwards refer to the number of parts of the relevant ingredient and all parts are by weight. The inks may be applied to paper by thermal, piezo or Memjet ink jet printing.

The following abbreviations are used in Tables I and II:
PG=propylene glycol
DEG=diethylene glycol
NMP=N-methylpyrrolidone
DMK=dimethylketone
IPA=isopropanol
MeOH=methanol
2P=2-pyrrolidone
MIBK=methylisobutyl ketone
P12=propane-1,2-diol
BDL=butane-2,3-diol
Surf=Surfynol™ 465 from Air Products
PHO=Na₂HPO₄ and
TBT=tertiary butanol
TDG=thiodiglycol
GLY=Glycerol
nBDPG=mono-n-butyl ether of dipropylene glycol
nBDEG=mono-n-butyl ether of diethylene glycol
nBTEG=mono-n-butyl ether of triethylene glycol

TABLE I

| | EPD | | | | | | | Na | | | | | | |
|---|---|---|---|---|---|---|---|---|---|---|---|---|---|---|
| EPD | Content | Water | PG | DEG | NMP | DMK | NaOH | Stearate | IPA | MEOH | 2P | MIBK | GLY | nBDPG |
| 1 | 30 | 50 | 5 | | 6 | 3 | | | | | 5 | | 1 | |
| 1 | 30 | 59.8 | | 5 | 5 | | 0.2 | | | | | | | |
| 1 | 40 | 45 | 3 | | 3 | 3 | | | | 5 | 1 | | | |
| 1 | 40 | 51 | | 8 | | | | | | | | 1 | | |
| 1 | 40 | 45.8 | 5 | | | | | 0.2 | 4 | | | 5 | | |
| 1 | 40 | 41 | | | 9 | | 0.5 | 0.5 | | | 9 | | | |
| 1 | 40 | 10 | 4 | 15 | 3 | 3 | | | 6 | 10 | 5 | 4 | | |
| 1 | 40 | 30 | | 20 | | | | | 9 | | | | | 1 |
| 1 | 50 | 25 | 5 | 4 | | 5 | | | | 6 | | 5 | | |
| 1 | 50 | 29.7 | 3 | 5 | 2 | 10 | | 0.3 | | | | | | |
| 1 | 50 | 15 | | 5 | 4 | 6 | | | 5 | 4 | 6 | 5 | | |
| 1 | 50 | 46 | | | | | | | | 4 | | | | |
| 1 | 40 | 50 | 5 | | | | | | 5 | | | | | |
| 1 | 40 | 40 | 2 | 6 | 2 | 5 | | | 1 | | 4 | | | |
| 1 | 40 | 40 | | 5 | | | | | | | 15 | | | |
| 1 | 40 | 44 | | | 11 | | | | | | 5 | | | |
| 1 | 50 | 30 | 2 | | | 10 | | | | 2 | | 6 | | |
| 1 | 50 | 39.7 | | | | 7 | 0.3 | | 3 | | | | | |
| 1 | 40 | 29 | 2 | 20 | 2 | 1 | | | | | 3 | 3 | | |
| 1 | 40 | 51 | | | 4 | | | | | | 5 | | | |
| 1 | 40 | 40 | | | | | | | | | | | 20 | |
| 1 | 40 | 40 | | | | | | | | | | | | 20 |

TABLE II

| | EPD | | | | | | | | | | | | | |
|---|---|---|---|---|---|---|---|---|---|---|---|---|---|---|
| EPD | content | Water | PG | DEG | NMP | Surf | TBT | TDG | BDL | PHO | 2P | PI2 | nBDEG | nBTEG |
| 1 | 30 | 49.8 | 15 | | | 0.2 | | | | | 5 | | | |
| 1 | 30 | 58.8 | | 5 | | | | | | 1.2 | | 5 | | |
| 1 | 40 | 44.6 | 5 | 5 | | 0.1 | 4 | 0.2 | | | | | | 1 |
| 1 | 40 | 5 | | 6 | 4 | 5 | | | | 0.12 | | | | |
| 1 | 40 | 49.8 | 4 | 8 | | | | | | | | 6 | | |
| 1 | 40 | 8 | | 10 | | 0.3 | | | 5 | 0.2 | | | | |
| 1 | 50 | 41.7 | | 5 | 5 | | | 0.3 | | | | | | |
| 1 | 50 | 44.8 | | 10 | 4 | | | | 1 | | 4 | 11 | | |
| 1 | 40 | 39.7 | 4 | 10 | 3 | | | | 2 | | 6 | | | |
| 1 | 40 | 20 | | | 6 | | | | | | 3 | | | |
| 1 | 40 | 35 | | 9 | 7 | | 2 | | | 0.95 | 5 | | 1 | |
| 1 | 40 | 51 | 5 | 11 | | | | | | | 6 | | | |
| 1 | 50 | 35.0 | | | 7 | | | | | | 7 | | | |
| 1 | 50 | 5 | 5 | 5 | 4.1 | | 0.2 | 0.1 | 5 | 0.1 | 5 | | | |
| 1 | 40 | 38 | | 10 | | 1 | | | | | | | | |
| 1 | 40 | 36 | | | | | | 10 | | | | | | |
| 1 | 30 | 24.5 | | | 5 | | | 12 | | | 5 | | | |
| 1 | 30 | 50 | 2 | | 8 | | | 15 | | | 5 | | | |
| 1 | 40 | 50 | | | | | | 8 | | | 12 | | | |
| 1 | 40 | 48 | | 10 | | | | | | | | | 10 | |
| 1 | 40 | 40 | | | | | | | | | 10 | | | 10 |

1. A dispersion of an encapsulated particulate solid obtained by a process comprising the steps in the order I) followed by II):
I) providing a dispersion comprising a particulate solid, a liquid medium and a dispersant which is obtained or obtainable by copolymerising a monomer composition comprising at least the ethylenically unsaturated monomers in components a) to d):
a) from 0.1 to 30 parts of one or more ethylenically unsaturated monomers of the Formula (1): 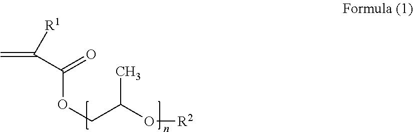
wherein R¹ is H or CH₃, R² is H or C₁₋₃₀ alkyl and n is 1 or more;
b) from 45 to 95 parts one or more ethylenically unsaturated monomers of the Formula (2): 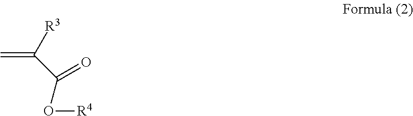
wherein R³ is H or CH₃ and R⁴ is a C₆₋₃₀ alkyl group;
c) from 5 to 30 parts of one or more ethylenically unsaturated monomers each having one or more ionic groups; and
d) from 0.1 to 15 parts of one or more ethylenically unsaturated monomers of the Formula (3): 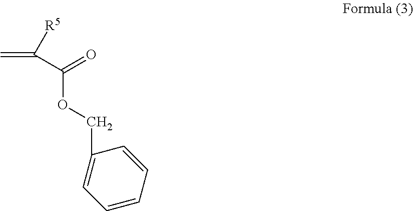
wherein R⁵ is H or CH₃;
wherein the parts are by weight and the sum of all the monomers present in the monomer composition adds up to 100;
II) cross-linking the dispersant in the presence of the particulate solid and the liquid medium and thereby encapsulating each particulate solid particle within a cross-linked dispersant shell.

2. A dispersion according to claim 1 wherein the dispersant prior to cross-linking has a solubility in water of at least 20% by weight when measured at a temperature of 25° C.

3. A dispersion according to claim 1 wherein component a) is present in the monomer composition in an amount from 10 to 25 parts by weight.

4. A dispersion according to claim 1 wherein in Formula (1) n is from 1 to 10.

5. A dispersion according to claim 1 wherein in Formula (1) R¹ is CH₃ and R² is H.

6. A dispersion according to claim 1 wherein in Formula (2) R⁴ is a 2-ethyl hexyl group.

7. A dispersion according to claim 1 wherein in Formula (3) R⁵ is CH₃.

8. A dispersion according to claim 1 wherein d) is present in an amount from 1 to 10 parts by weight.

9. A dispersion according to claim 1 wherein the monomer composition additionally comprises component e) from 0 to 10 of one or more ethylenically unsaturated monomers other than those in components a) to d).

10. A dispersion according to claim 9 wherein component e) does not comprise an ethylenically unsaturated monomer having a polyethyleneoxy group.

11. A dispersion according to claims 1 wherein the monomer composition comprises only the monomers in components a) to d) and the sum of the parts of a) to d) is 100.

12. A dispersion according to claim 1 wherein the cross-linking in step II) is effected by the addition of an epoxy cross-linking agent.

13. A dispersion according to claim 1 wherein the particulate solid is a yellow pigment.

14. A dispersion according to claim 1 wherein the particulate solid is an azo pigment.

15. A dispersion according to claim 14 wherein the azo pigment is a compound comprising a group of the Formula (4): 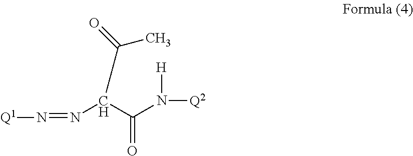
wherein Q¹ and Q² are each independently optionally substituted aryl groups.

16. A dispersion according to claim 1 wherein the particulate solid is selected from C.I. Pigment Yellow 1, 3, 10, 12, 13, 14, 17, 55, 65, 73, 74, 75, 83, 93, 97, 109, 111, 120, 128, 138, 139, 150, 151, 154, 155, 180, 185 and 213.

17. An ink jet printing ink comprising a dispersion according to claim 1.

18. An ink jet printer cartridge containing an ink jet printing ink according to claim 17.

19. An ink jet printer comprising an ink jet printer cartridge according to claim 18.

20. A method for preparing the dispersion according to claim 1 comprising the steps in the order I) followed by II):
I) providing a dispersion comprising a particulate solid, a liquid medium and a dispersant which is obtained or obtainable by copolymerising a monomer composition comprising at least the ethylenically unsaturated monomers in components a) to d):
a) from 0.1 to 30 parts of one or more ethylenically unsaturated monomers of the Formula (1): 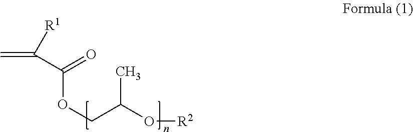
wherein R¹ is H or CH₃, R² is H or C₁₋₃₀ alkyl and n is 1 or more;
b) from 45 to 95 parts one or more ethylenically unsaturated monomers of the Formula (2): 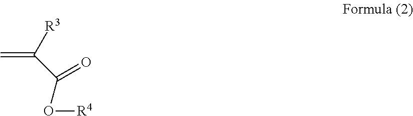
wherein R³ is H or CH₃ and R⁴ is a C₆₋₃₀ alkyl group;
c) from 5 to 30 parts of one or more ethylenically unsaturated monomers each having one or more ionic groups; and
d) from 0.1 to 15 parts of one or more ethylenically unsaturated monomers of the Formula (3): 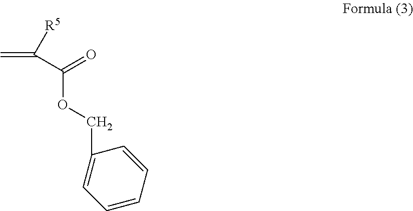
wherein R⁵ is H or CH₃;
wherein the parts are by weight and the sum of all the monomers present in the monomer composition adds up to 100;
II) cross-linking the dispersant in the presence of the particulate solid and the liquid medium and thereby encapsulating each particulate solid particle within a cross-linked dispersant shell.
